(19) United States
(12) Patent Application Publication
(10) Pub. No.: US 2012/0101517 A1
(43) Pub. Date: Apr. 26, 2012

(54) ACUPRESSURE MASSAGE PILLOW

(76) Inventor: Sung Won Kang, Incheon (KR)

(21) Appl. No.: 13/002,723

(22) PCT Filed: Jul. 6, 2010
(86) PCT No.: PCT/KR2010/004379

§ 371 Date: Jan. 5, 2011

(30) Foreign Application Priority Data
Jul. 10, 2009 (KR) 10-2009-0063138

(51) Int. Cl. A61H 39/04

(52) U.S. Cl. 606/204

(57) ABSTRACT

The present invention relates to an acupressure massage pillow including: a body having a space portion formed thereinto and a plurality of first through-holes formed on the center of the top surface thereof to correspond to the acupressure points on a rear head section; a first massage plate disposed in the space portion of the body and having a plurality of massage protrusions formed thereon in such a manner as to be moved upwardly and downwardly through the first through-holes from/into the space portion of the body; a first raising and lowering means adapted to raise and lower the first massage plate; a controller adapted to control the first raising and lowering means; and a power supply means adapted to supply actuating power of the controller.

### BACKGROUND OF THE INVENTION

1. Field of the Invention

The present invention relates to an acupressure massage pillow, and more particularly, to an acupressure massage pillow that is capable of effectively massaging the acupressure points on a user's head section while the user is sleeping.

2. Background of the Related Art

Generally, there are about 365 acupressure points along acupuncture meridians in the human body, at which the reaction to diseases is expressed sensitively.

On the other hand, various kinds of massage pillows have been proposed to massage a head section so as to provide deep sleep to a user.

An one of conventional massage pillows, there is proposed Korean Utility Model Registration No. 20-0334906, which discloses a pillow for health that is designed to apply a cushion force while a user's head is being positioned thereon during sleeping or taking a rest and to massage the user's head with an appropriate force by means of massage protrusions made of soft urethane foam, thereby allowing the blood circulation of the user's head to be smoothly performed, the pillow for health including a body made of soft urethane foam having a high cushion effect with a predetermined curvature corresponding to a head section of a human body and having upper and lower neck supporting parts different from each other at their height, the upper neck supporting part having the massage protrusions formed as a unitary body therewith, and a pillow cover made of a smooth material having high water absorption.

Most of the conventional massage pillows are structured to have a plurality of massage protrusions formed upwardly from the pillow body, thus to uniformly massage the head section of the user, but they fail to effectively massage the acupressure points on the user's head section on which specific massage is needed.

Additionally, lots of the conventional massage pillows are configured to have the plurality of massage protrusions still protruded even while the user is sleeping, such that the acupressure points on the head section of the user are kept at pressed states, thereby inhibiting the smooth blood circulation of the user and further causing the head section of the user to be painful. Also, since the massage marks on the head section still remain after the massaging, the head skin is not restored for a while to their original state after his sleeping, which looks bad.

Further, the conventional massage pillows do not provide comfortable and pleasant feelings to users.

### SUMMARY OF THE INVENTION

Accordingly, the present invention has been made in view of the above-mentioned problems occurring in the prior art, and it is an object of the present invention to provide an acupressure massage pillow that is capable of effectively massaging the acupressure points on a head section to provide gentle blood circulation and rapid fatigue recovery.

It is another object of the present invention to provide an acupressure massage pillow that is capable of providing various additional functions in accordance with a user's selection.

To accomplish the above objects, according to the present invention, there is provided an acupressure massage pillow including: a body having a space portion formed thereinto and a plurality of first through-holes formed on the center of the top surface thereof to correspond to the acupressure points on a rear head section; a first massage plate disposed in the space portion of the body and having a plurality of massage protrusions spaced apart from each other by a predetermined distance thereon in such a manner as to be moved upwardly and downwardly through the first through-holes from/into the space portion of the body; a first raising and lowering means adapted to raise and lower the first massage plate such that the plurality of first massage protrusions are moved upwardly and downwardly through the first through-holes from/into the space portion of the body; a controller adapted to control the first raising and lowering means; and a power supply means adapted to supply actuating power of the controller.

According to the present invention, preferably, the body has a plurality of external air-flowing holes formed on the sides thereof, through which external air flows, and a plurality of air-discharging holes formed on the top surface thereof so as to discharge the air flowing through the external air-flowing holes to the outside; the space portion of the body has an air-blowing fan adapted to forcedly absorb the external air through the external air-flowing holes and then to discharge the external air to the outside through the air-discharging holes and a blower motor adapted to rotate the air-blowing fan; and the controller has an air-blowing operation switch.

According to the present invention, preferably, the controller controlling the first raising and lowering means has a microcomputer having a control function, a first selection switch adapted to select the activation of the first raising and lowering means, and a time setting switch adapted to set a period of time for maintaining the raised state of the first raising and lowering means.

According to the present invention, preferably, the first massage plate has a plurality of first guide members protrudedly formed on the underside thereof so as to guide the first massage plate while the first massage plate is being moved upwardly and downwardly and to prevent the first massage plate from escaping from its movement, and the body has a plurality of first guide grooves formed on the bottom of the inside thereof so as to guide the plurality of first guide members.

According to the present invention, preferably, the body has a plurality of second and third through-holes formed thereon to corresponding to the acupressure points on a right side head section and a left side head section, and the space portion of the body has second and third massage plates having a plurality of second and third massage protrusions spaced apart from each other by a predetermined distance thereon in such a manner as to be moved upwardly and downwardly through the second and third through-holes from/into the space portion of the body and second and third raising and lowering means adapted to raise and lower the second and third massage plates under the control of the controller.

According to the present invention, preferably, the controller controlling the second and third raising and lowering means has a microcomputer having a control function and second and third selection switches for selecting the activation of the second and third raising and lowering means.

According to the present invention, preferably, the second and third massage plate have a plurality of second and third guide members protrudedly formed on the underside thereof so as to guide the second and third massage plates while the second and third massage plates are being moved upwardly and downwardly and to prevent the second and third massage plates from escaping from their movement, and the body has a plurality of second and third guide grooves formed on the bottom of the inside thereof so as to guide the plurality of second and third guide members.

According to the present invention, preferably, the space portion of the body has a heater and a temperature sensor for sensing a temperature during the activation of the heater, and the controller has a temperature setting switch provided thereon.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing an acupressure massage pillow according to a first embodiment of the present invention;

FIG. 2 is a schematic view showing acupressure points on a rear head section of a human body;

FIG. 3 is a schematic view showing acupressure points on a right head section of a human body;

FIG. 4 is a schematic view showing acupressure points on a left head section of a human body;

FIG. 5 is a plan view showing the acupressure massage pillow according to the first embodiment of the present invention;

FIG. 6 is a sectional view taken along the line A-A of FIG. 5;

FIG. 7 is a sectional view taken along the line B-B of FIG. 5;

FIG. 8 is a circuit diagram showing the acupressure massage pillow according to the first embodiment of the present invention;

FIGS. 9 and 10 are sectional views showing the operating states of the acupressure massage pillow according to the first embodiment of the present invention before and after massaging for the acupressure points on the rear head section;

FIGS. 11 and 12 are sectional views showing the operating states of the acupressure massage pillow according to the first embodiment of the present invention before and after massaging for the acupressure points on the left head section;

FIG. 13 is a plan view showing an acupressure massage pillow according to a second embodiment of the present invention;

FIG. 14 is a front sectional view of FIG. 13;

FIG. 15 is a front sectional view showing an acupressure massage pillow according to a third embodiment of the present invention;

FIG. 16 is a sectional view showing one side of FIG. 15; and

FIG. 17 is a perspective view showing an acupressure massage pillow according to a fourth embodiment of the present invention.

### DETAILED DESCRIPTION OF THE PREFERRED EMBODIMENT

Hereinafter, an explanation on an acupressure massage pillow according to preferred embodiments of the present invention will be in detail given with reference to the attached drawings.

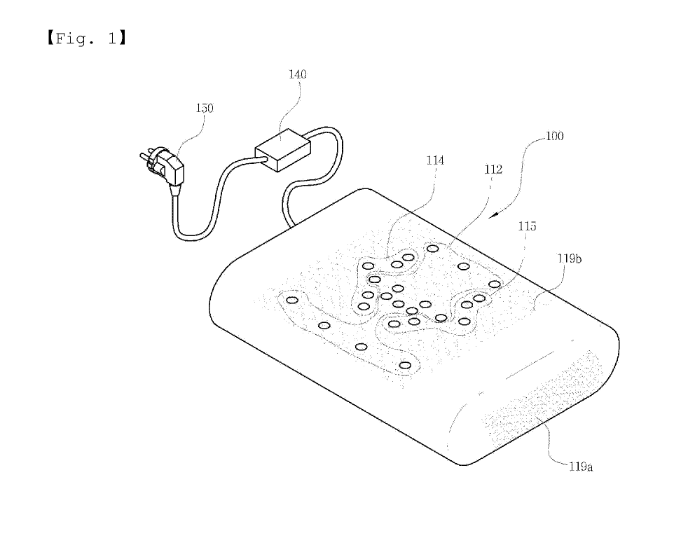

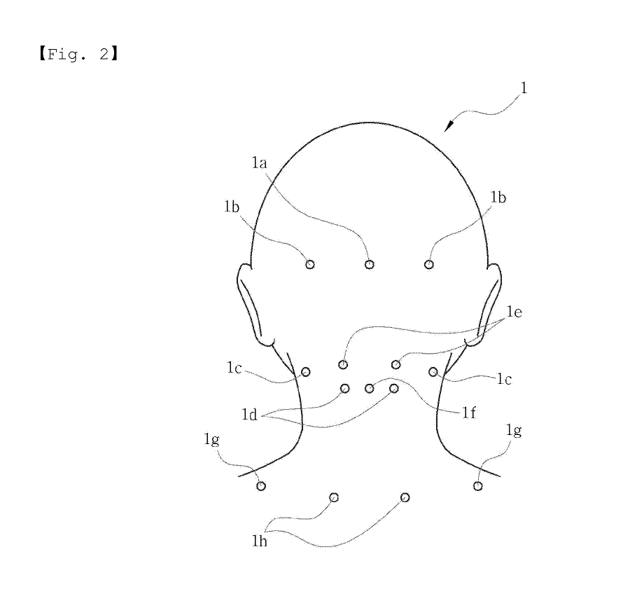

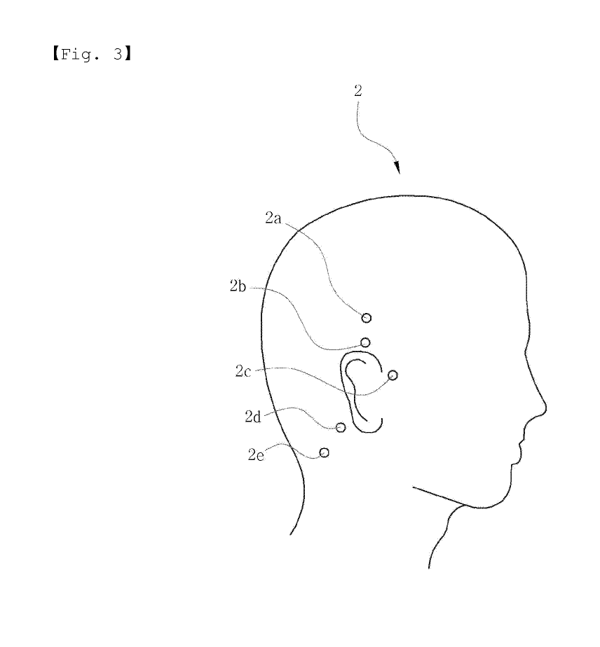

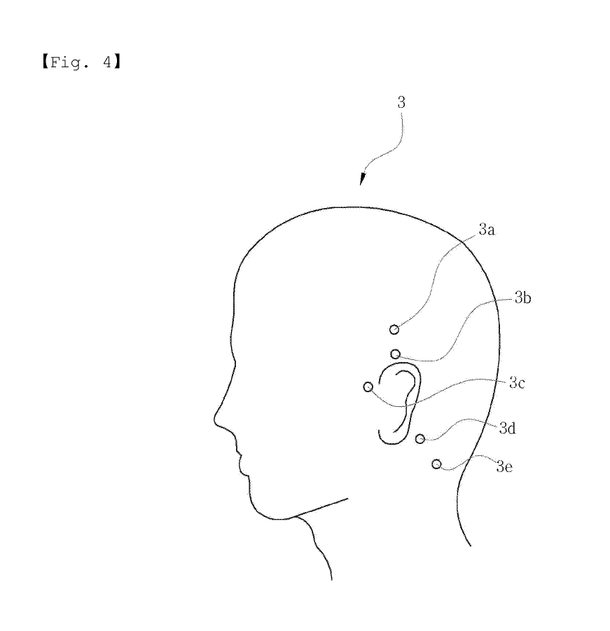

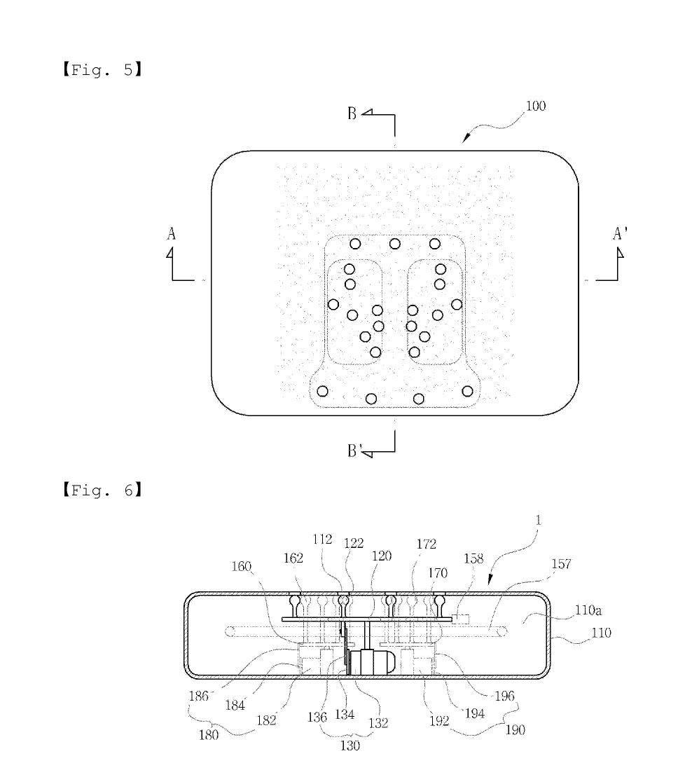

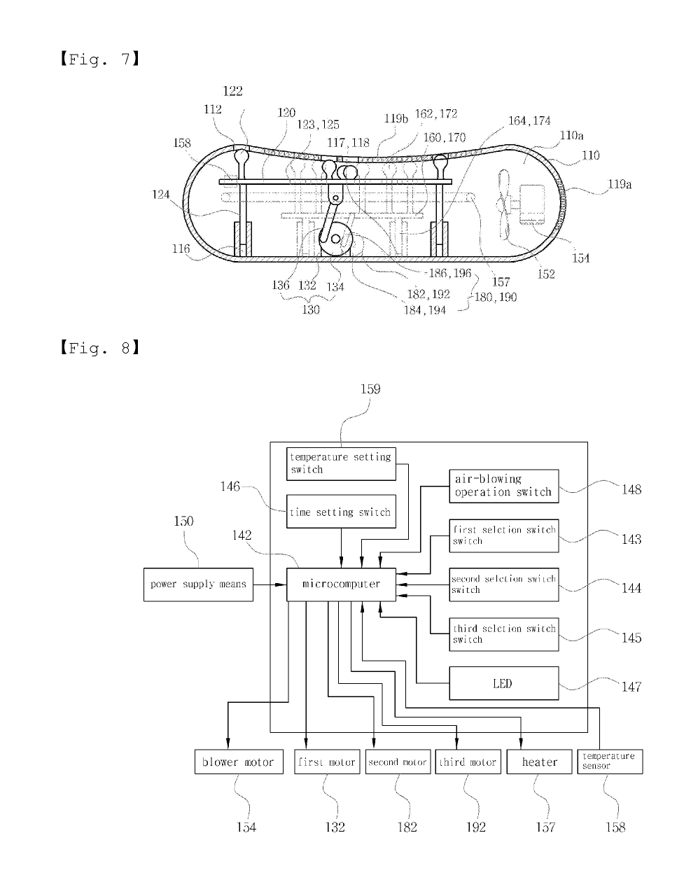

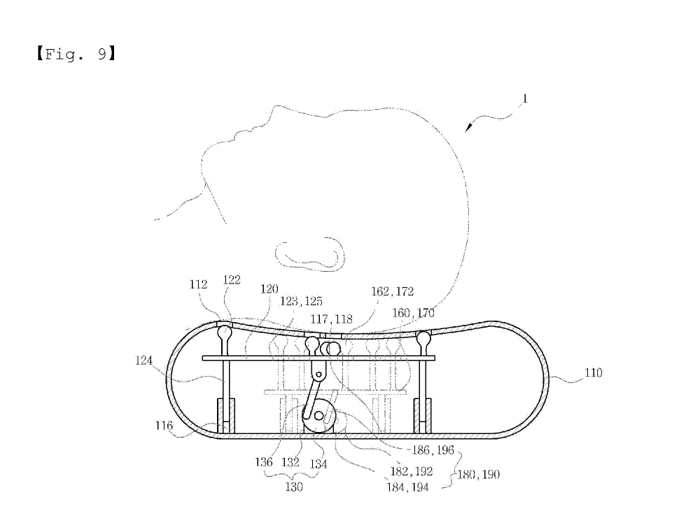

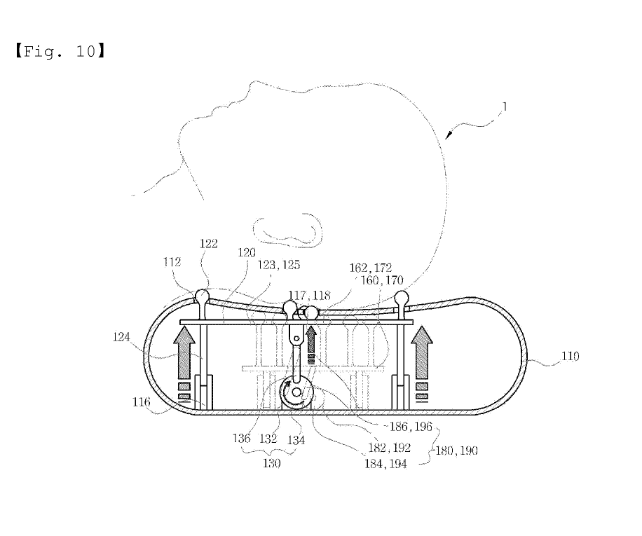

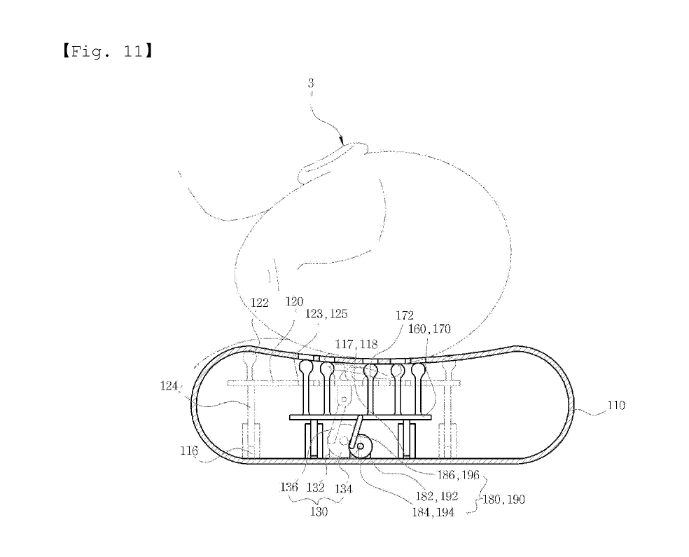

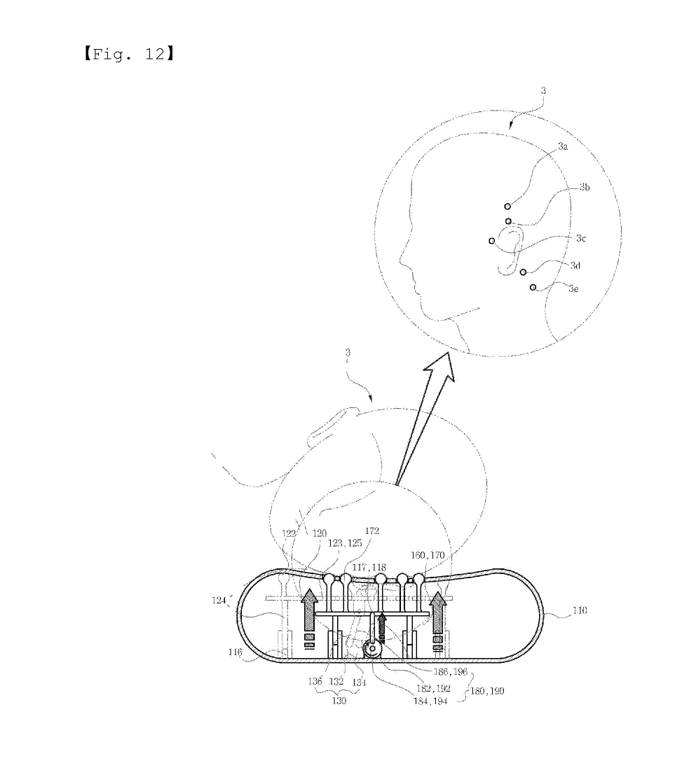

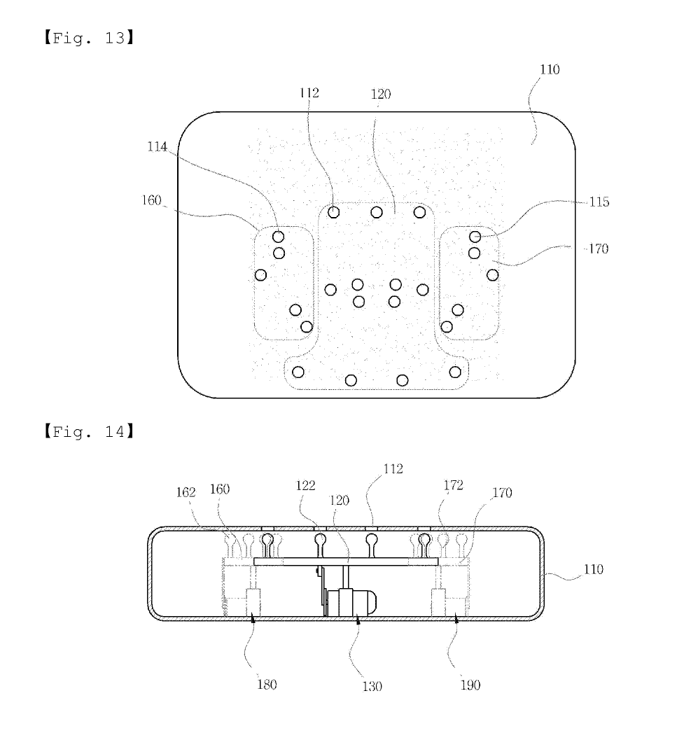

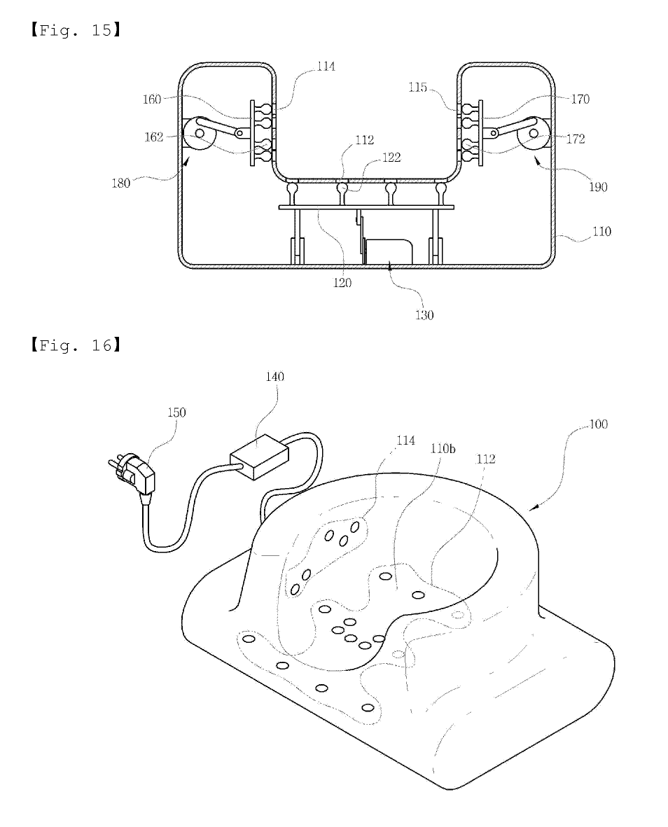

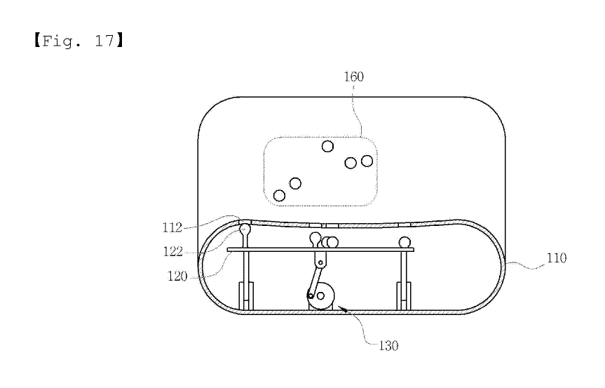

FIG. 1 is a perspective view showing an acupressure massage pillow according to a first embodiment of the present invention, FIG. 2 is a schematic view showing acupressure points on a rear head section of a human body, FIG. 3 is a schematic view showing acupressure points on a right head section of a human body, FIG. 4 is a schematic view showing acupressure points on a left head section of a human body, FIG. 5 is a plan view showing the acupressure massage pillow according to the first embodiment of the present invention, FIG. 6 is a sectional view taken along the line A-A of FIG. 5, FIG. 7 is a sectional view taken along the line B-B of FIG. 5, FIG. 8 is a circuit diagram showing the acupressure massage pillow according to the first embodiment of the present invention, FIGS. 9 and 10 are sectional views showing the operating states of the acupressure massage pillow according to the first embodiment of the present invention before and after massaging for the acupressure points on the rear head section, FIGS. 11 and 12 are sectional views showing the operating states of the acupressure massage pillow according to the first embodiment of the present invention before and after massaging for the acupressure points on the left head section, FIG. 13 is a plan view showing an acupressure massage pillow according to a second embodiment of the present invention, FIG. 14 is a front sectional view of FIG. 13, FIG. 15 is a front sectional view showing an acupressure massage pillow according to a third embodiment of the present invention, and FIG. 16 is a sectional view showing one side of FIG. 15.

Referring to FIGS. 1 to 12, an acupressure massage pillow 100 according to a first embodiment of the present invention includes a body 110 having a space portion 110a formed thereinto and a plurality of first through-holes 112 formed on the center of the top surface thereof to correspond to the acupressure points on a rear head section 1; a first massage plate 120 disposed in the space portion 110a of the body 110 and having a plurality of massage protrusions 122 spaced apart from each other by a predetermined distance thereon in such a manner as to be moved upwardly and downwardly through the first through-holes 112 from/into the space portion 110a of the body 110; a first raising and lowering means 130 adapted to raise and lower the first massage plate 120 such that the plurality of first massage protrusions 122 are moved upwardly and downwardly through the first through-holes 112 from/into the space portion 110a of the body 110; a controller 140 adapted to control the first raising and lowering means 130; and power supply means 150 adapted to supply actuating power of the controller 140.

At this time, the first through-holes 112 and the first massage protrusions 122 are formed to massage the acupressure points on the rear head section 1 of the head. The acupressure points on the rear head section 1 of the head include one Noeho 1a positioned at a depressed portion above 5 pun from an external occipital protuberance, two Noegong 1b positioned at 2 chop lateral to the Naeho 1a, two Pungji 1c positioned at both side depressed portions of the lower side of the rear head section, two Cheonju 1d positioned distant by 5 pun from a portion in which hair grows, that is, on the trunks of cervical muscles, two Sangcheonju 1e positioned above 5 pun from the two Cheonju 1d, one Amun 1f positioned between the two Cheonju 1d, two Kyeunjung 1g positioned at the rear shoulder portions, and two Pungmun 1h positioned at the spine portion below a neck section.

At this time, if the Naegong 1b is massaged, rear head pain, empyema or dizziness is healable, if the Pungji 1c is massaged, stroke, failing of eyesight, or dizziness is healable, if the Cheonju 1d is massaged, fever, headache, or insomnia is healable, and if the Sangcheonju 1e is massaged, headache or mental disorder is healable. Also, massaging on the Kyeunjung 1g and the Pungmun 1h is helpful for healing shoulder stiffness or fatigue accumulation. Further, there are various acupressure points like the Amun 1f positioned between the two Cheonju 1d, and if the Amun 1f is massaged, hypertension is healable.

At this time, the body 110 is generally rounded to support a user's head and shoulders to provide comfortable feeling in use to the user.

In this case, on the upper side of the body 110 are provided the first through-holes 112 formed at the positions corresponding to one Noeho 1a, two Noegong 1b, two Pungji 1c, two Cheonju 1d, two Sangcheonju 1e, and one Amun 1f, and on the lower side of the body 110 are provided the first through-holes 112 formed at the positions corresponding to two Kyeunjung 1g and two Pungmun 1h.

Further, the body 110 has a plurality of second and third through-holes 114 and 115 formed thereon to correspond to the acupressure points on a right side head section 2 and a left side head section 3 so as to heal a migraine headache and so on. In more detail, the second and third through-holes 114 and 115 are formed on the body 110 at the positions corresponding to Solgok 2a and 3a, Gakson 2b and 3b, Gaekjooin 2c and 3c, Wangol 2d and 3d, and Cheonju 2e and 3e as the acupressure points formed on the right and left sides of the head.

In the space portion 110a of the body 110 are provided second and third massage plates 160 and 170 having a plurality of second and third massage protrusions 162 and 172 spaced apart from each other by a predetermined distance thereon in such a manner as to be moved upwardly and downwardly through the second and third through-holes 114 and 115 from/into the space portion 110a of the body 110 and second and third raising and lowering means 180 and 190 adapted to raise and lower the second and third massage plates 160 and 170 under the control of the controller 140. On the other hand, if necessary, the first to third through-holes 112, 114 and 115 and the first to third massage protrusions 122, 162 and 172, which are moved upwardly and downwardly through the first to third through-holes 112, 114 and 115, may be selectively formed at positions where appropriate healing is required.

The body 110 is made of a variety of materials such as plastic, metal, ceramic and so on.

As mentioned above, the upwardly and downwardly moving first to third massage plates 120, 160 and 170 and the first to third raising and lowering means 130, 180 and 190 are disposed in the space portion 110a of the body 110. In more detail, the first massage plate 120 has the plurality of massage protrusions 122 formed on the top thereof in such a manner as to be moved upwardly and downwardly through the first through-holes 112 from/into the space portion 110a of the body 110 and a plurality of first guide members 124 protrudedly formed on the underside thereof so as to guide the first massage plate 120 while the first massage plate 120 is being moved upwardly and downwardly and to prevent the first massage plate 120 from escaping from its movement.

Also, the first massage plate 120 has the first raising and lowering means 130 disposed therebelow, and the first raising and lowering means 130 is configured wherein a first disc 134 is provided as a unitary body with a rotary shaft of a first motor 132, and if the first motor 132 is rotated through the control of the controller 140, one side of the first disc 134 and the underside of the first massage plate 120 are connected by means of a first link 136, such that when the first disc 134 is rotated, the first link 136 is rotated to a predetermined angle to allow the first massage plate 120 to be raised and lowered.

On the other hand, on the surface of the first massage plate 120 are provided a plurality of first and second guide through-holes 123 and 125 through which the second and third massage protrusions 162 and 172 are passed, and at the left and right sides below the first massage plate 120 are provided the second and third massage plates 160 and 170 having the second and third massage protrusions 162 and 172 formed thereon in such a manner as to be passed through the first and second guide through-holes 123 and 125 and then moved upwardly and downwardly through the second and third through-holes 114 and 115 from/into the space portion 110a of the body 110. Further, a plurality of second and third guide members 164 and 174 are protrudedly formed on the undersides of the second and third massage plates 160 and 170 so as to guide the second and third massage plates 160 and 170 while the second and third massage plates 160 and 170 are being moved upwardly and downwardly and to prevent the second and third massage plates 160 and 170 from escaping from their movement.

Of course, the body 110 has a plurality of first to third guide grooves 116, 117 and 118 formed on the bottom of the inside thereof so as to guide the plurality of first to third guide members 124, 164 and 174.

The second and third massage plates 160 and 170 have the second and third raising and lowering means 180 and 190 disposed therebelow, and the second and third raising and lowering means 180 and 190 are configured wherein second and third discs 184 and 194 are provided as a unitary body with rotary shafts of second and third motors 182 and 192, and if the second and third motors 182 and 192 are rotated through the control of the controller 140, one sides of the second and third discs 184 and 194 and the undersides of the second and third massage plates 160 and 170 are connected by means of second and third links 186 and 196, such that when the second and third discs 186 and 196 are rotated, the second and third links 186 and 196 are rotated to a predetermined angle to allow the second and third massage plates 160 and 170 to be raised and lowered.

On the other hand, the controller 140 controlling the first to third raising and lowering means 130, 180 and 190 includes a microcomputer 142 having a control function, first to third selection switches 143, 144 and 145 for selecting the activation of the first to third raising and lowering means 130, 180 and 190, a time setting switch 146 for setting a period of time for maintaining the raised state of the selected any one of the first to third raising and lowering means 130, 180 and 190, and a light emitting diode (LED) 147 for displaying on/off states.

The power supply means 150 for supplying actuating power of the controller 140 makes use of household electric power converted through an adapter, or a battery.

In the meanwhile, on the side surfaces of the body 110 are provided a plurality of external air-flowing holes 119a through which external air flows, and on the top surface of the body 110 are provided a plurality of air-discharging holes 119b for discharging the air flowing through the external air-flowing holes 119a to the outside. Also, the space portion 110a formed inside the body 110 includes an air-blowing fan 152 adapted to forcedly absorb the external air through the external air-flowing holes 119a and then to discharge the external air to the outside through the air-discharging holes 119b, and a blower motor 154 adapted to rotate the air-blowing fan 152. The controller 140 includes an air-blowing operation switch 148. Accordingly, if the air-blowing operation switch 148 is operated, air is discharged through the air-discharging holes 119b formed on the top surface of the body 110, such that a user can sleep at a fresh and comfortable state.

So as to obtain a fomentation effect, on the other hand, the space portion 110a of the body 110 has a heater 157 and a temperature sensor 158 for sensing a temperature during the activation of the heater 157, and the controller 140 has a temperature setting switch 159 provided thereon. Accordingly, if the temperature setting switch 159 is operated, the temperature sensed through the temperature sensor 158 and the temperature set by the temperature setting switch 159 are compared by means of the microcomputer 142. So, if the temperature sensed is less than the temperature set by the temperature setting switch 159, the heater 157 is activated, and contrarily, if the temperature sensed is more than the temperature set by the temperature setting switch 159, the activation of the heater 157 stops.

At this time, it is desirable that so as to allow far-infrared rays to be penetrated deeply to the user's head skin while the fomentation is performed, far-infrared ray radiation paint is applied to the surface of the body 110. Also, it is desirable that the first to third massage protrusions 122, 162 and 172 are made of a magnet or jade.

Under the above-mentioned configuration of the acupressure massage pillow according to the present invention, when any one of the first to third selection switches 143, 144 and 145 is manipulated to perform the acupressure massage on the rear head section 1, the right head section 2, or the left head section 3, any one of the first to third raising and lowering means 130, 180 and 190 is activated.

For example, if the first raising and lowering means 130 is activated, the first motor 132 is rotated forwardly to pressurize and raise the underside of the first massage plate 120, and in this case, the first massage protrusions 122 formed on the surface of the first massage plate 120 perform acupressure massage, while being passed through the first through-holes 112 of the body 110 and moved upwardly from the space portion 110a of the body 110.

At this time, if the massage time is set, for example, to 20 minutes by means of the time setting switch 146, the first motor 132 of the first raising and lowering means 130 is rotated reversely after the 20 minutes have passed, and the first massage plate 120 is moved downwardly into the space portion 110a of the body 110, so that the acupressure massage is not performed further more, thereby providing a comfortable sleeping state to the user. In this case, it is desirable that the operation of the blower motor 154 stops at the same time.

Further, the body 110 may have a base plate (not shown) provided at the lower portion thereof and an automatically or manually operating adjuster (not shown) provided on the base plate so as to adjust the height of the body 110, so that the height of the body 110 can be appropriately adjusted in accordance with the conveniences of adults, children, and aged and disability.

Also, the body 110 can be inclined in every direction, which allows the user to feel very comfortable when he watches TV or takes a rest.

On the other hand, FIGS. 13 and 14 are plan and sectional views showing an acupressure massage pillow according to a second embodiment of the present invention. In a configuration of the acupressure massage pillow according to the second embodiment of the present invention, a plurality of first though holes 112 are formed on the center of the top surface of a body 110, and a first massage plate 120 is provided on the center of the space portion formed inside the body 110. Further, second and third massage plates 160 and 170 are provided at the left and right sides of the first massage plate 120. A first raising and lowering means 130 is provided below the first pressure plate 120, a second raising and lowering means 180 is below the second massage plate 160, and a third raising and lowering means 190 is below the third massage plate 170.

Under the above-mentioned configuration, if a user lies on his back on the center of the body 110, the first raising and lowering means 130 is operated to massage the acupressure points on the rear head section, and if he lies on his left or right side on a left or right side of the body 110, the second or third raising and lowering means 180 or 190 is operated to massage the acupressure points on the left or right head section, thereby obtaining massaging effects.

FIGS. 15 and 16 are sectional views showing an acupressure massage pillow according to a third embodiment of the present invention. In a configuration of the acupressure massage pillow according to the third embodiment of the present invention, a body 110 has a head-seating recess 110b formed concavedly to seat a user's head section thereinto, a plurality of first though holes 112 formed at the bottom of the center thereof, and second and third through-holes 114 and 115 formed on the left and right walls of the head-seating recess 110b. Further, second and third massage plates 160 and 170 are provided at the left and right sides. A first raising and lowering means 130 is provided below the first pressure plate 120, a second raising and lowering means 180 is at the rear of the second massage plate 160, and a third raising and lowering means 190 is at the rear of the third massage plate 170.

At this time, the first to third raising and lowering means 130, 180 and 190 may be formed of various mechanisms like rack and pinion.

Under the above-mentioned configuration, if a user lies on his back on the center of the body 110, the first to third raising and lowering means 130, 180 and 190 are operated at the same time or any one of them is operated selectively to massage the acupressure points on desired sections of the head.

FIG. 17 is a perspective view showing an acupressure massage pillow according to a fourth embodiment of the present invention.

In a configuration of the acupressure massage pillow according to the fourth embodiment of the present invention, a body 110 has a head-seating recess 110b formed concavedly to seat a user's head section thereinto, such that the rear head section, the top side head section, and the left and right head sections are all seated thereinto. At this time, the body 110 further has a plurality of fourth though holes 113 formed at the top side thereof so as to massage the acupressure points like Backhoe, Tongcheon, Hujeong, Jeonjeong and so on and a fourth raising and lowering means (not shown) on which a plurality of fourth massage protrusions (not shown) are formed in such a manner as to be moved upwardly and downwardly through the fourth through-holes from/into the space portion thereof. Under the above-mentioned configuration, the whole acupressure points on the head section are massaged to improve the acupressure massaging effects.

As set forth in the foregoing, according to the acupressure massage pillow of the present invention, the acupressure points on the head section of the human body are effectively massaged to help blood circulation and fatigue recovery of the user and to provide deep sleep to the user.

According to the acupressure massage pillow of the present invention, additionally, the air-blowing fan is provided to allow external air to flow into the interior of the pillow and to discharge the air flowing into the pillow through the top surface of the pillow, thereby allowing the user to feel fresh and comfortable during his sleeping.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An acupressure massage pillow comprising:
a body having a space portion formed thereinto and a plurality of first through-holes formed on the center of the top surface thereof to correspond to the acupressure points on a rear head section;
a first massage plate disposed in the space portion of the body and having a plurality of massage protrusions spaced apart from each other by a predetermined distance thereon in such a manner as to be moved upwardly and downwardly through the first through-holes from/into the space portion of the body;
a first raising and lowering means adapted to raise and lower the first massage plate such that the plurality of first massage protrusions are moved upwardly and downwardly through the first through-holes from/into the space portion of the body;
a controller adapted to control the first raising and lowering means; and
a power supply means adapted to supply actuating power of the controller.

2. The acupressure massage pillow according to claim 1, wherein the body has a plurality of external air-flowing holes formed on the sides thereof, through which external air flows, and a plurality of air-discharging holes formed on the top surface thereof so as to discharge the air flowing through the external air-flowing holes to the outside; the space portion of the body has an air-blowing fan adapted to forcedly absorb the external air through the external air-flowing holes and then to discharge the external air to the outside through the air-discharging holes and a blower motor adapted to rotate the air-blowing fan; and the controller has an air-blowing operation switch.

3. The acupressure massage pillow according to claim 1, wherein the controller controlling the first raising and lowering means has a microcomputer having a control function, a first selection switch adapted to select the activation of the first raising and lowering means, and a time setting switch adapted to set a period of time for maintaining the raised state of the first raising and lowering means.

4. The acupressure massage pillow according to claim 1, wherein the first massage plate has a plurality of first guide members protrudedly formed on the underside thereof so as to guide the first massage plate while the first massage plate is being moved upwardly and downwardly and to prevent the first massage plate from escaping from its movement, and the body has a plurality of first guide grooves formed on the bottom of the inside thereof so as to guide the plurality of first guide members.

5. The acupressure massage pillow according to claim 1, wherein the body has a plurality of second and third through-holes formed thereon to corresponding to the acupressure points on a right side head section and a left side head section, and the space portion of the body has second and third massage plates having a plurality of second and third massage protrusions spaced apart from each other by a predetermined distance thereon in such a manner as to be moved upwardly and downwardly through the second and third through-holes from/into the space portion of the body and second and third raising and lowering means adapted to raise and lower the second and third massage plates under the control of the controller.

6. The acupressure massage pillow according to claim 5, wherein the controller controlling the second and third raising and lowering means has a microcomputer having a control function and second and third selection switches for selecting the activation of the second and third raising and lowering means.

7. The acupressure massage pillow according to claim 5, wherein the second and third massage plate have a plurality of second and third guide members protrudedly formed on the underside thereof so as to guide the second and third massage plates while the second and third massage plates are being moved upwardly and downwardly and to prevent the second and third massage plates from escaping from their movement, and the body has a plurality of second and third guide grooves formed on the bottom of the inside thereof so as to guide the plurality of second and third guide members.

8. The acupressure massage pillow according to claim 1, wherein the space portion of the body has a heater and a temperature sensor for sensing a temperature during the activation of the heater, and the controller has a temperature setting switch provided thereon.
